(19) United States
(12) Patent Application Publication
(10) Pub. No.: US 2003/0079384 A1
(43) Pub. Date: May 1, 2003

(54) Marketing of watches and the like

(76) Inventor: CarIo Santoro, Toronto (CA)

Correspondence Address: David W.R. Langton, Bereskin & Parr, Box 401, 40 King Street West, Toronto, ON, M5H 3Y2, CA

(21) Appl. No.: 09/984,598

(22) Filed: Oct. 30, 2001

(51) Int. Cl. B42F 21/00; B65D 27/00

(52) U.S. Cl. 40/360

(57) ABSTRACT

Watches, jewellery and like articles are marketed by advertising the article in a magazine or advertising display. For example, a page of the magazine carries advertising matter for a watch or jewellery. A life-like representation of the watch or jewellery article is detachably attached to the substrate so that it can be removed and tried on to simulate wear of an actual watch or jewellery article.

### FIELD OF THE INVENTION

This invention relates generally to the marketing of personal wear articles such as watches, bracelets and other articles of jewellery.

### BACKGROUND OF THE INVENTION

Watches and jewellery items are marketed extensively through advertising in fashion or “lifestyle” magazines and other publications. Perusal of a typical such publication will reveal numerous high quality advertisements for watches and jewellery. Usually, the advertisements are full page and the watches or jewellery articles are shown life size and in full colour.

An object of the present invention is to provide improvements relating to the marketing of personal wear articles such as watches, bracelets and other articles of jewellery.

### SUMMARY OF THE INVENTION

One aspect of the invention provides a method of marketing personal wear articles by means of an advertisement which comprises a substrate bearing advertising matter relating to one or more such articles, and at least one representation comprising a life-like simulation of an actual said article. The representation is detachably attached to the substrate, so that the representation can be removed and tried on by a person seeing the advertisement, to simulate wear of an actual article.

Another aspect of the invention provides an advertising display comprising a substrate bearing advertising matter relating to one or more personal wear articles, and at least one representation comprising a life-like simulation of an actual article,. The representation is detachably attached to the substrate, so that the representation can be removed and tried on by a person seeing the advertisement, to simulate wear of an actual article.

Advertising watches or jewellery in this way has the advantage that a person seeing the advertisement has the option to try on a realistic representation of the article in question so that he or she can visualize what the article will look like in wear. While the advertisement could be a single sheet in the nature of a “flyer” or a stand-up display in a commercial environment, preferably the advertisement is incorporated in a magazine or other publication. Ideally, several pages of the magazine comprise advertisements in accordance with the invention so that the reader is presented with a range of options for different, say, watches or jewellery articles to be tried on.

In its simplest form, the substrate of the advertisement is a page of a magazine and the representation is attached to the edge of the page at a tear line, for example, a line of perforations. The representation may be in effect a continuation of the page delimited by the perforations. In the case of a watch, the representation may be incorporated in a thin rectangular “fold-out” panel along one edge of the page. The watch may be represented laid flat including a strap so that the representation of the watch extends along the relevant edge of the page. Most watch designs do not have a rectangular profile when laid flat with the strap, so the panel itself may incorporate tear-off areas that are removed to produce the shape of the watch itself. In another example, the fold-out panel could be in the shape of the watch and strap, and be attached to the substrate at a number of tear-off points rather than along the full edge of the page.

In another embodiment, the representation of the article may be secured to the substrate by a relatively low-strength adhesive so that the representation can be peeled off the substrate without tearing.

The representation itself may be provided with adhesive areas that remain after the representation has been removed from the substrate, to facilitate simulated wearing of the article by a user. For example, in the case of a watch, adhesive areas may be provided at one or both ends of the strap portion so that the strap can be placed around the wearer's wrist and the ends adhered together, to better simulate the appearance of the watch in wear. In the case of jewellery articles, the adhesive may be used to temporarily adhere the article to the wearer's body or clothes.

### BRIEF DESCRIPTION OF DRAWINGS

In order that the invention may be more clearly understood, reference will now be made to the accompanying drawings which illustrate a number of preferred embodiments of the invention by way of example, and in which:

FIG. 1 is a perspective view of a magazine shown open at a page that comprises an advertising display in accordance with one embodiment of the invention;

FIG. 2 is a view similar to FIG. 1 showing a detachable panel folded out from the page that is shown in FIG. 1;

FIG. 3 is a perspective view showing part of a magazine page in accordance with a further embodiment of the invention;

FIG. 4 is a sectional view on line IV-IV of FIG. 3;

FIG. 5 shows a watch representation as having been removed from the magazine page and placed on a wearer's wrist;

FIG. 6 is a perspective view of a magazine page showing a jewellery advertisement in accordance with a further preferred embodiment of the invention; and,

FIG. 7 is a perspective view of a person shown wearing the jewellery representations of FIG. 6.

### DESCRIPTION OF PREFERRED EMBODIMENTS

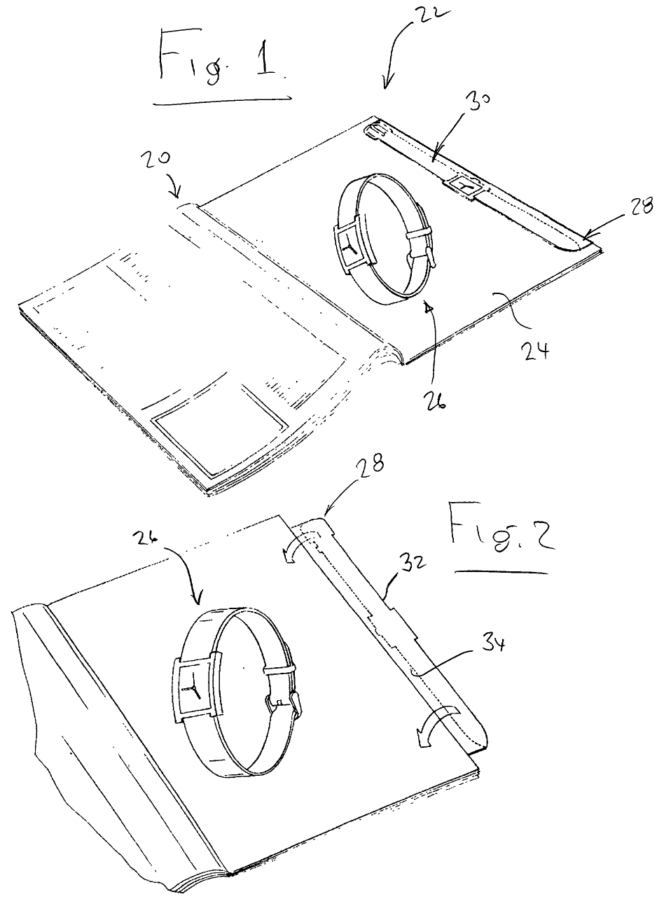

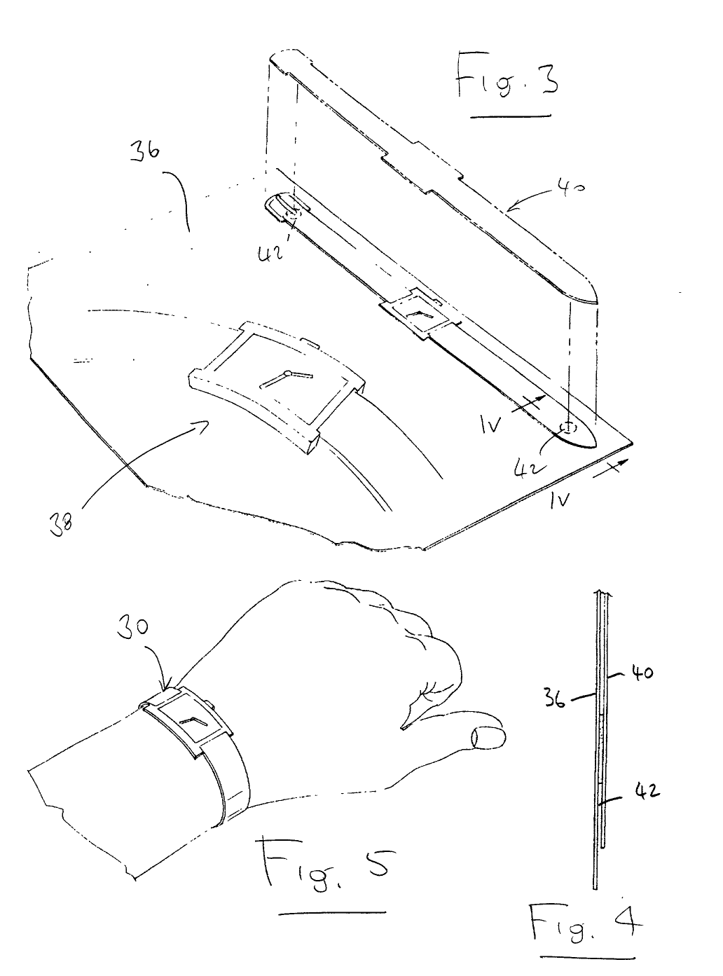

Referring first to FIGS. 1 and 2, a magazine 20 is shown as having been opened to a page that comprises an advertising display 22 in accordance with the invention. The display is provided by a substrate that in this embodiment is a printed page 24 of the magazine bearing advertising matter 26, in this case relating to a watch. For purposes of illustration, the advertising matter is shown as a watch that has a band in a looped configuration as in wear. However, the advertising matter may take any appropriate form and may include illustrations of the several watches as well as text. FIG. 1 is intended to be illustrative only.

Detachably attached to the page 24 along its outer edge parallel to the spine is a fold-out panel 28 that is made from the same stock as the page itself. In FIG. 1, the panel 28 is shown folded in on top of an outer marginal edge portion of page 24. The magazine normally will be distributed with the panel 28 in this position. Panel 28 includes a printed representation 30 that is a life-like simulation of the actual watch shown in the advertisement. Typically, the advertisement is a glossy full-colour printed page, and representation 30 is rendered in similar fashion.

Representation 30 is detachable from the page 24 so that it can be removed and “tried on” by a person seeing the advertisement, to simulate wear of the actual article. FIG. 2 shows the panel 28 as having been folded out for detachment of the representation 28. It will be seen that the outer edge 32 of panel 28 is shaped to follow the contour of one outer edge of the watch and strap laid flat. A corresponding line of perforations 34 defines the opposite edge of the watch. Once the panel 28 has been folded out to the position shown in FIG. 2, the representation 30 can be detached from the remainder of the panel. That remainder can simply be left as an appendage to the page or can itself be detached from the page at a further line of perforations (not shown) co-incident with the outer edge of the page.

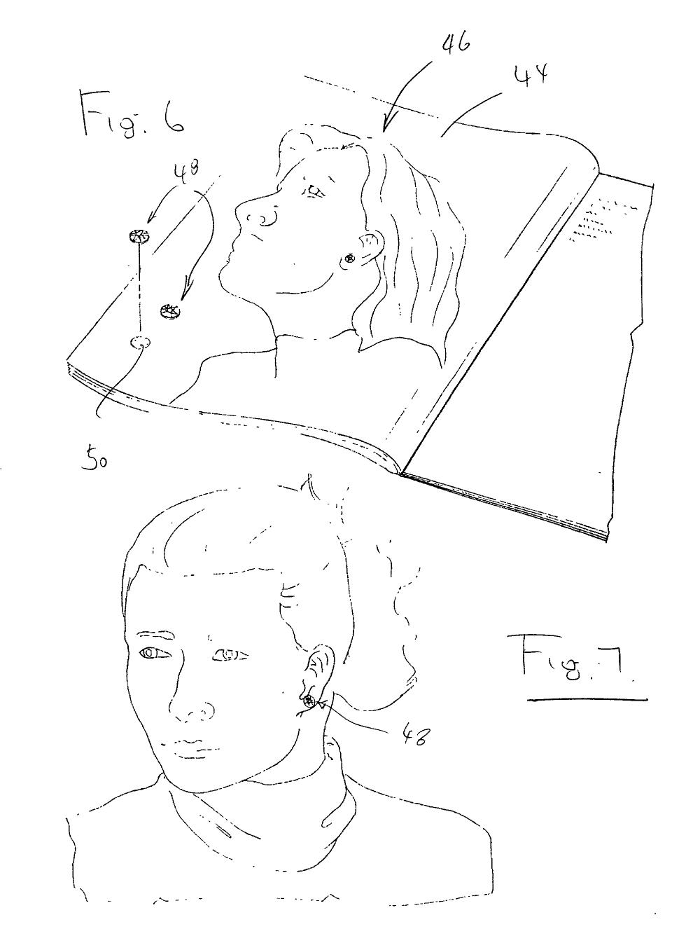

FIG. 5 shows the representation 30 as having been looped around the wrist of a wearer so that the wearer can visualize what the watch will look like in wear. The ends of the strap can simply be held in place on the user's wrist, or the ends of the strap of the representation can be temporarily attached together to give an even more realistic impression of how the watch will appear in wear. For example, lateral slits may be provided in respective ends of the strap so that the ends can be inter-engaged with one another and temporarily held in place. Other methods of achieving temporary attachment can be visualized.

FIG. 3 illustrates an embodiment in which the representation of the watch is detachable attached to the substrate by means of a relatively low-strength adhesive so that the representation can be removed from the substrate. Preferably, the same adhesive can then be used to secure together ends of the strap.

As seen in FIG. 3 the substrate in this case is shown as a single sheet 36 in the nature of a “flyer” or stand-up display for use in a commercial environment. The substrate may be made of somewhat heavier stock than the paper stock used for magazine pages. It is of course to be understood that the embodiment of FIG. 3 could also be applied to a magazine page. In this case, the substrate 36 carries advertising matter 38 which may be of any appropriate form. Detachably attached to the substrate is a representation 40 of the watch. In this case, the representation 40 is pre-cut in the shape of a watch and strap laid flat. The representation 40 is secured to the substrate 36 by pads or patches 42 of low-strength adhesive that are applied between end portions of the strap of the representation and the substrate. Thus, the representation 40 is held in place on the substrate until required to be tried on, when it can be peeled off at the pads or patches 42. The representation can then be looped around the wearer's wrist as shown in FIG. 5. The adhesive pads or patches 42 are designed to remain at least in part on the representation after it has been removed from the substrate so that the adhesive at one end of the strap can be adhered to the top surface of the strap at the other end for securing the representation around the wrist of the wearer as shown in FIG. 5.

In the embodiment of FIG. 3, the representation 40 can be made of the same stock as the substrate 36, or different stock. The representation could even be a printed plastic sheet. Though cost and thickness may be an issue in some applications, it is even possible that the representation could be a three-dimensional moulded article.

Finally, FIGS. 6 and 7 illustrate an embodiment of the invention as applied to the marketing of jewellery articles. In FIG. 6, the advertising display of the invention is again shown in the form of a page of a magazine (in this case denoted 44). Advertising matter 46 appears on the face of the page. In this case, the advertisement is for earrings and the page carries two representations of earrings, denoted 48 that are held in place by low-strength adhesive pads as in the embodiment of FIG. 3, and one of which is indicated at 50. Again, the representations 48 can be removed from the substrate 44 without tearing and some adhesive will remain with the representations and can be used to temporarily adhere the representation to the wearer's body or clothes. In FIG. 7, one of the representations 48 is shown in place on the earlobe of a wearer.

It will of course be appreciated that the embodiments illustrated are representative only and that a number of possible modifications may be made, some of which have been mentioned and others of which will be apparent to a person skilled in the art. For example, other methods of attachment of the representation to the substrate are possible. The representation could be tucked into slits or a pocket on the substrate. In an embodiment applied to a magazine, the representation could be arranged to “pop up” when the page is opened, in the manner of illustrations in children's books.

A single substrate may carry more than one representation.

I claim:

1. A method of marketing personal wear articles, which comprises advertising said articles in an advertisement comprising a substrate bearing advertising matter relating to said personal wear articles, and at least one representation comprising a life-like simulation of an actual said article, said representation being detachably attached to the substrate, so that the representation can be removed and tried on by a person seeing the advertisement, to simulate wear of an actual said article.

2. An advertising display comprising a substrate bearing advertising matter relating to said personal wear articles, and at least one representation comprising a life-like simulation of an actual said article, said representation being detachably attached to the substrate, so that the representation can be removed and tried on by a person seeing the advertisement, to simulate wear of an actual said article.

3. An advertising display as claimed in claim 2, wherein said substrate comprises a page of a magazine.

4. An advertising display as claimed in claim 2, wherein said representation comprises a panel detachably attached to an edge of said substrate.

5. An advertising display as claimed in claim 2, wherein said representation is separate from said substrate and detachably attached thereto by a low-strength adhesive but permits removal of the representation from the substrate without tearing.

6. An advertising display as claimed in claim 5, wherein said adhesive remains with the representation after it has been removed from the substrate and is located on the representation so that the adhesive can be used to secure the representation in wear.
